(19) United States
(12) Patent Application Publication
(10) Pub. No.: US 2005/0229472 A1
(43) Pub. Date: Oct. 20, 2005

(54) Fishing tackle and line holder

(75) Inventor: Jeffrey Mark Jost, Bell Canyon, CA (US)

Correspondence Address: Jeffrey Jost, 2 Cinch Road, Bell Canyon, CA, 91307, US

(73) Assignee: EFS, Inc., Bell Canyon, CA (US)

(21) Appl. No.: 11/106,890

(22) Filed: Apr. 15, 2005

Related U.S. Application Data
(60) Provisional application No. 60/562,744, filed on Apr. 16, 2004.

(51) Int. Cl. A01K 97/06

(52) U.S. Cl. 43/25.2

(57) ABSTRACT

A fishing line and/or terminal tackle holder for supporting the free end of a fishing line or its terminal when transporting the fishing gear. The apparatus includes a slot within a mass therein for receiving the line and/or terminal tackle and a clipping structure for securing the mass to the fishing rod.

### RELATED APPLICATIONS

This application claims priority to U.S. patent application Ser. No. 60/562,744, which is incorporated herein by reference.

### FIELD OF THE INVENTION

The present invention relates generally to holders for fishing terminal tackle such as sinkers, hooks, swivels, lures, and the like. More particularly, the invention relates to an apparatus for a detachable clip for securing and supporting terminal tackle during temporary storage and transport of an assembly of fishing gear.

### DESCRIPTION

### BACKGROUND OF THE INVENTION

The present invention provides a detachable clip for securing terminal tackle such as sinkers, hooks, swivels, lures and the like on a fully rigged fishing pole. More particularly, the invention relates to an apparatus for a detachable clip for securing and supporting terminal tackle during temporary storage and transport of an assembly of fishing gear.

In sport fishing, either fresh or salt water, it is often desirable to move from fishing spot to fishing spot. The fishing gear, including the rod, line, and terminal tackle, is already assembled, or fully rigged. Transport may occur by foot, automobile, cycle, boat or other means of transport, which may require temporary storage of the assembled fishing gear. During transport, a free end of the line extends from the tip of the rod to the terminal tackle, including lures, hooks, swivels, shot, sinkers, and the like. In order to avoid snagging and tangling of this free end of line the angler is usually required to hold the line taut or secure the loose end by some other means. Unless properly secured, this causes great inconvenience to the angler since it could cause entanglement and/or potentially dangerous unwieldy terminal tackle, such as a loose flying hook or heavy sinker.

Different solutions have been proposed in the past, some as simple as fastening the hook to a secure spot on the assembled fishing gear to utilizing devices such as hook holders or line holders. The cheapest and simplest method has been to secure the hook to the reel or rod guide and make taut the fishing line to keep it in place. Various devices are disclosed in the prior art which attach the terminal tackle to the rod to perform this function. Although these methods may reduce somewhat the problem of the hook, this does nothing to eliminate or reduce the problem of a loose and unanchored sinker, which are normally placed at the terminal point or attached a few feet above the hook.

Other solutions have been proposed such as line holders, for example, the Fishing Line Holder disclosed in U.S. Pat. No. 4,457,095 (Stevenson, R. F.). Such devices accommodate different lengths of leader and secure terminal tackle to the rod, including multiple pieces of terminal tackle (e.g., by use of multiple devices). However, because such devices rely on friction to secure the fishing line, they potentially damage or weaken the fishing line. In addition, such devices are designed to be placed in a fixed location and are not easily adjusted up or down the rod without having to un-secure and re-secure the device each time.

Other devices for holding terminal tackle have been proposed, such as the one disclosed in U.S. Pat. No. 5,020,264, which discloses a Velcro mounted terminal tackle holder. Although this device accommodates different types of terminal tackle, it suffers because it is inconvenient to separate the two Velcro sides repeatedly to remove the tackle. In addition, the Velcro suffers because it attaches to other unintended items, causing greater inconvenience. In addition, Velcro has a pre-determined cycle life (number of openings and closings) before it fails to function properly.

A few fixed-spool reels have an integral line clip built into the spool. The function of this line clip is not for securing terminal tackle, but rather for securing the line to the spool when removed from the reel. The integral line clip is designed to keep the line wound taut around the spool without unraveling. A second purpose for the integral line clip is to retain the line at a fixed point to ensure accurate casting distance.

The use of rubber bands to secure the line requires two hands to secure and retrieve the line or terminal tackle. Rubber bands deteriorate quickly when exposed to sun and water and, although they are inexpensive and readily available, they are not reliable.

With respect to terminal tackle holders or line holders, such devices to date also suffer because they are 1) not easily or conveniently adjustable and 2) inconvenient in such as it requires the angler to use more then one hand to secure the line, lure, and/or terminal tackle. In addition, they require complete removal and re-placement and are thus inconvenient to keep pace with the ever-changing fishing conditions, which may require quickly adjusting the fishing set-up.

Accordingly, prior approaches to providing a solution to the problems of securing terminal tackle in a convenient and efficient manner have generally failed.

### SUMMARY OF THE INVENTION

In its basic concept the apparatus of the present invention is a fishing line holder for securing terminal tackle on a fully rigged fishing pole (which may or may not include the bait). The device comprises a block having a slot therein for receiving the line and means for securing the block on the rod.

Accordingly, it is the general object of the present invention to provide a fishing line holder for securing the free end of the fishing line along with its terminal tackle during transport of the gear assemblage.

Another object is to provide an apparatus, which does not interfere with bait on the hook.

Yet another object is to provide a fishing line holder, which is simple and easy to install and use.

A further object is to provide a device, which is of low cost and is easy to manufacture.

These and other objects and advantages of the present invention and the manner in which they are achieved will be made apparent in the following specification and claims.

### BRIEF DESCRIPTION OF THE DRAWINGS

FIG. 1 is a fragmentary elevation of the first embodiment of the fishing line holder.

FIG. 2 is a fragmentary elevation of a set of fishing gear including the first embodiment of the fishing line holder of the present invention.

FIG. 3 is a cross sectional view of the fishing line holder.

### DESCRIPTION OF THE PREFERRED EMBODIMENTS

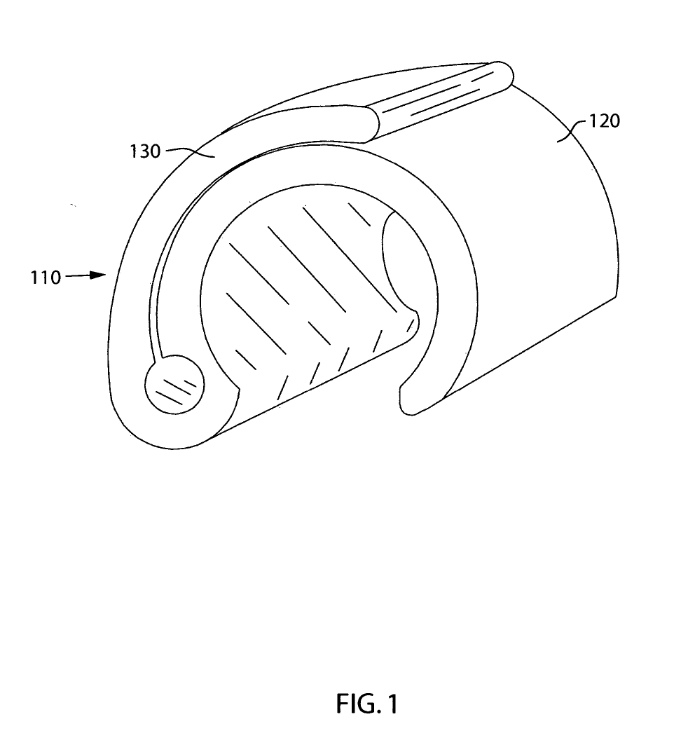

The present invention provides a detachable clip 110 for holding terminal tackle. As illustrated in FIG. 1, the invention device 110 comprises a pliable body portion 120, which can clip to varying diameters of a fishing rod and a terminal tackle clip 130, which can hold terminal tackle or line. In the most preferred embodiment, the body portion comprises a clam-shaped or ‘C’-shaped pliable body 120, which clamps around the rod at a minimum of two contact points. The body is preferably of a design, which partially or wholly encircles the circumference of the rod at the point of desirable contact. Because the body is pliable, it can easily adjust to varying circumferences, from the top of the rod to the butt of the rod. In addition, this allows the holder device to be conveniently and efficiently adjusted to varying set-ups by sliding up or down or alternatively removed and reattached elsewhere on the rod. Preferably, the body is made of such pliable material as to not damage the rod if slid up or down, or during clipping. Such materials include rubber, vinyl, plastics, metals (preferably coated), variations, or derivative thereof, which allows flexibility, durability, and resiliency. Most preferably, the body will be made of a material, which allows the body to retain its shape in all types of conditions and over repeated use. In addition, the present invention can be made in any color or texture.

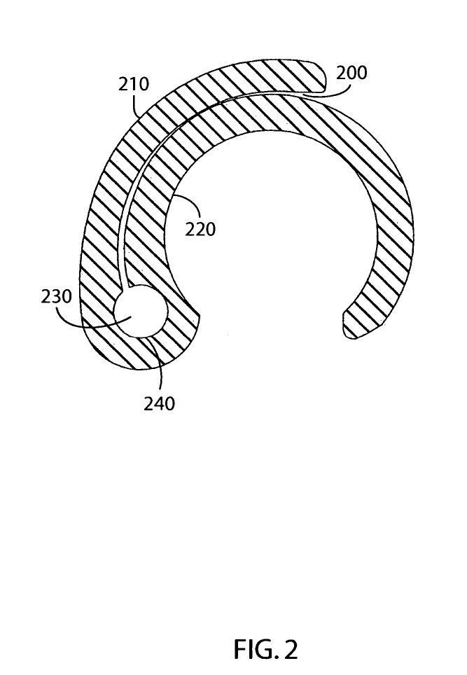

As illustrated in FIG. 2, the present invention further comprises a terminal tackle clipping means 200, which fastens the terminal tackle securely to the rod or thereabout. Preferably, the clipping means is a pliable flap 210 made of the same material as the body. In this embodiment, the flap 210 extends from the body 220 and creates a layer parallel with the body. This layer can follow the contour of the clip entirely or in part, but is of a size sufficient to hold a terminal tackle. Preferably, the clipping means will be smaller in profile than the body, particularly in the area away from the tip of the rod, or placed a small distance from the body, so that if the terminal tackle wiggles, little or no damage will occur to the rod itself.

The clipping means can be made of materials distinct from the body or similar to the body, and can be made as a continuous flow of the body or be securely mounted to the body. In addition, the clipping means 200 can be adjacent to the body or slightly separated, to allow the terminal tackle to sit a short distance from the rod. Preferably, the clip and body, in conjunction, will be streamlined as to not protrude and easily catch on foreign objects. In addition, or alternatively, the outer edge of the clipping means can be flared out or upwards to facilitate engagement with the line and or allow pulling on the clipping means.

In a preferred embodiment of the present invention, the clipping means 200 is created by the flap 210 and the body 220. When the terminal tackle or fishing line is emplaced between the body and the flap, the terminal tackle is held in place by the flap, or alternatively, by tightening the fishing line to secure the terminal tackle in place.

The device may further comprise a longitudinal slot 230 defined therein for accommodation of fishing line. This may be created at the juncture between the body and the clipping means by a small hollowed out channel 230. When placed about a fishing rod, the fishing line would fit through the slot to the terminal tackle. When pulled taut, the terminal tackle would snugly fit against the lower end (away from rod tip) 240 of the flap and/or body, restraining the terminal tackle in place. In a preferred embodiment, the outer edge(s) of the slot can be flared to facilitate engagement with the line and or tackle.

One or more of the devices may be used on a rod concurrently, and the equipment may be properly secured thereby. One may use, for example, a holder on the line, the leader, the hook, the lure, and/or the sinker.

The invention may be manufactured in a few dimensions as to allow for the varying diameters of current and future fishing rods.

Beyond the obvious aspects, the present invention also offers the multiple advantages of being of light weight construction, convenient adjustability, waterproof (and therefore shrink proof), low-profile, and of low cost.

Other advantages and features of the present invention will become apparent from the following detailed description when read in conjunction with the accompanying drawing.

### OPERATIONS

When a fisherman decides to move from fishing spot to fishing spot he will retrieve his line by cranking the reel handle, leaving a length of free line with whatever terminal tackle is attached, normally less than the length from the tip of the rod to the reel, handle, or butt of the rod. He will then lift the rod tip thereby swinging the end of the line towards him for the purposes of securing line, lure, and/or terminal tackle. The line, lure, and/or terminal tackle are typically caught in the opposite hand of the one holding the rod either above or below the hook.

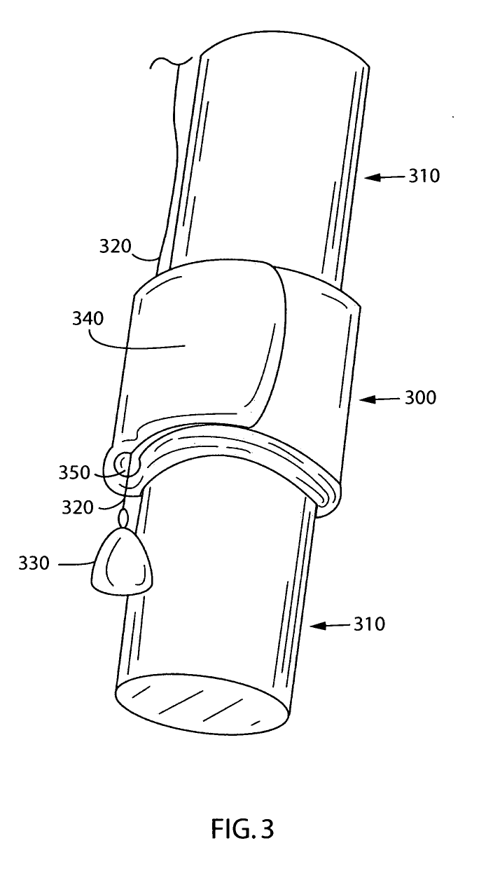

As seen in FIG. 3, with the device 300 in place anywhere on the rod 310 as desired by the angler, the angler grasps the line 320 near the desired secure point with the forefingers and thumb bringing it towards the device 300.

In a preferred method, the terminal tackle 330 or the line 320 is then pressed into the clipping means 340 of the holder 300 of the present invention, shown in its first embodiment. If a slot 350 is present, the line 320 adjacent to the terminal tackle 330 is placed in the slot 350 with or without a portion of the terminal tackle 330 within.

The line 320 may then be tensioned either by continuing to retrieve the line by cranking the reel handle or by sliding the device 300 towards the butt end of the rod until the fishing line 320 becomes taut. Either of these methods will pull the terminal tackle into abutment with the side of block as shown in FIG. 3. The line is secured within the slot. The line only may be secured at any point without tensioning.

The device will also accept the short protruding barrel or wire that exits many common drop-shot or down-shot sinker designs.

Multiple clips may be employed for each terminal tackle or various points of the line.

Placement of the device on the rod may vary because the placement of the terminal tackle may vary. Because the fishing conditions may vary for placement of the terminal tackle, the clip can be re-positioned by sliding up or down the rod or by removal and reattachment to accommodate the new placement. This is particularly applicable in the case of adjustable drop shot placement, which can be slid up and down the fishing line to accommodate the fishing conditions.

Because the device is durable, resilient and pliable, it will retain its' shape and contour of the rod so it does not slip during significant pressure from the tautness of the line.

The terminal tackle may be released at will by either releasing the tension of the line or by simply unclipping the terminal tackle.

The holder according to the present invention can appear on the rod more than once, as a holder. The holders may be fitted around a rod body of the fishing rod as illustrated. The holders are shown in FIG. 1 as holding the hook and the eye of the sinker. The holders may be used to hold the line or the leader additionally.

Modifications thereto will become apparent to those skilled in the art to which it pertains without deviation from the spirit of the invention as defined by the scope of the appended claims.

1. A pliable detachable holder for holding terminal tackle and/or fishing line, comprising:
a pliable ‘C’-shaped or semicircular body which is capable of clamping securely to a fishing rod, and
a clipping means for securing said terminal tackle and/or fishing line, wherein said clipping means is attached to said body.

2. The holder of claim 1, wherein the clipping means is a flap or flange extending from said body.

3. The holder of claim 2, wherein said clipping means is smaller than said body.

4. The holder of claim 1, wherein the holder further comprises a flap or flange extending from said body.

5. The holder of claim 4, wherein the clipping means comprise a slot formed at the juncture where the flap meets the body, wherein said slot accommodates fishing line.

6. The holder of claim 1, wherein a slot is formed at the juncture where the flap meets the body, wherein said slot accommodates fishing line.

7. The holder of claim 6, wherein the slot in the connecting mass is flared at its outer end to facilitate engagement with the line.

8. The holder of claim 1, wherein said holder is made of a resilient material.

9. The holder of claim 1, wherein said holder is made of rubber or a rubber composite.

10. The holder of claim 1, wherein said holder is made of a plastic or a polymer.

11. The holder of claim 10, wherein said holder is molded as one continuous unit, wherein said clipping means is a continuous extension of said body, formed as a parallel external layer to said body.

12. A plastic fishing line support comprising a pliable semicircular cylinder, which can be clipped to a fishing pole, wherein the cylinder further comprises an external parallel flexible flap that can engage fishing line.

13. The fishing line support of claim 12, wherein the support is injection molded.

14. A holder for supporting a fishing line, with or without a lure or other terminal tackle attached, a length of which extends from the tip of a fishing pole, the holder comprising:
a. a connecting mass having a slot therein for receiving the line; and
b. mounting means for securing the mass on the pole, the mounting means comprising a pole clipping structure having a flexible semicircular portion having substantially the same circumference as the pole for encircling the pole.

15. The holder of claim 14 wherein the slot is integrally formed with the connecting mass.

16. The fishing line holder of claim 14 wherein the slot in the connecting mass is flared at its outer end to facilitate engagement with the line.

17. The fishing line holder of claim I wherein the connecting mass is of resilient material.
